(19) United States
(12) Patent Application Publication
(10) Pub. No.: US 2017/0269789 A1
(43) Pub. Date: Sep. 21, 2017

(54) OPTICAL TOUCH DEVICE USING IMAGING MODULE

(71) Applicants: CHIH-HSIUNG LIN, New Taipei City (TW); SHIH-YUAN CHANG, Zhubei City (TW)

(72) Inventors: CHIH-HSIUNG LIN, New Taipei City (TW); SHIH-YUAN CHANG, Zhubei City (TW)

(73) Assignee: inFilm Optoelectronic Inc., Grand Cayman (KY)

(21) Appl. No.: 15/457,488

(22) Filed: Mar. 13, 2017

(30) Foreign Application Priority Data
Mar. 17, 2016 (TW) 105108293

(51) Int. Cl. G06F 3/042

(52) U.S. Cl. CPC G06F 3/0428; G06F 3/0425; G06F 2203/04109

(57) ABSTRACT

An optical touch device using imaging module according the present invention includes a guide light plate, at least a light source, an imaging module, at least a photosensitive unit and a microprocessor; the imaging module has at least an image reflective curved surface to image multiple contact positions to at least a photosensitive unit conveniently to form image information corresponding to the multiple contact positions so as to allow the microprocessor to generate corresponding touch signals; the images at where an object contacts the guide light plate are utilized directly to generate the touch signals instead of detecting attenuation signal of frustrated total internal reflection resulting from the object contacting the guide light plate; due to the light in the guide light plate is employed to conduct the total internal reflection propagation to attain touch control function, components needed in the touch device is reduced and the fabrication cost is saved largely.

### CROSS-REFERENCE TO RELATED APPLICATIONS

The application claims priority from Taiwan Patent Application No. 105108293 filed on Mar. 17, 2016, the disclosure of which is incorporated herein by reference.

### BACKGROUND OF THE INVENTION

1. Field of the Invention

The present invention relates to a touch device technique, and, more particularly, relates to a touch control technique with total internal reflection propagation in a guide light plate.

2. Description of Related Art

It is known that there are many guide light touch devices having been developed. For example, Taiwan Patent No. I 470508 teaches a touch panel which includes a guide light plate, multiple light sources and multiple detectors. The guide light plate has an upper surface, a lower surface, multiple lateral sides and multiple light entering surfaces. The light sources are disposed on the light entering surfaces, and the detectors are disposed corresponding to the light sources to receive light bundle signal from the light sources.

Further, Taiwan Patent No. I46038 discloses a guide light touch device in which light from a light emitting unit is guided into the guide light plate to conduct total internal reflection propagation, a microprocessor detects and compares multiple signals received by all the photosensitive units to confirm attenuation signal resulting from the FTIR (abbreviation of the frustrated total internal reflection generated by an object contacting the guide light plate and further confirm at least two photosensitive units having sensed the attenuation signal, obtains position information with respect to the touch point of the object contacting the upper surface of the guide light plate according to the positions of the two photosensitive units, and outputs a corresponding control signal.

The preceding touch panel and the guide light plate touch device are using the FTIR attenuation signal resulting from the object contacting the guide light plate being detected to obtain the touch position and output a corresponding control signal.

### SUMMARY OF THE INVENTION

In order to improve the conventional guide light plate, the present invention is proposed.

The main object of the present invention is to provide an optical touch device using imaging module with which merely an imaging module and a photosensitive unit are used to image multiple contact positions to the photosensitive unit conveniently to form image information corresponding to the multiple contact positions so as to generate corresponding touch signals, that is, the image of the object contacting the guide light plate being utilized directly to generate the touch signals instead of detecting the attenuation signal resulting from the FTIR at the time of the object contacting the guide light plate.

Another object of the present invention is to provide an optical touch device using imaging module with which the guide light plate can perform touch control function via a single imaging module with a photosensitive unit to reduce components required by the touch device and substantially save the fabricating cost.

The optical touch device using imaging module according to the present invention comprises:
a guide light plate having an upper surface and a lower surface being parallel to each other, and an operation zone disposed on the upper surface;
at least a light source emitting light being guided into the guide light plate and conducting total internal reflection propagation between the upper and lower surfaces;
an imaging module corresponding to the operation zone and having at least an image reflective cured surface;
at least a photosensitive unit corresponding to said imaging module; during the emitted light within the operation zone shooting the imaging module and being imaged to the photosensitive unit by the image reflective curved surface, the photosensitive unit sensing image information corresponding to an image in the operation zone; and
a
microprocessor electrically connecting the photosensitive unit; wherein when the emitted light is guided into the guide light plate to conduct total internal reflection propagation and at least an object touches at least a contact position in the operation zone, the total internal reflection is frustrated at the time of the light irradiating the contact position and reflected by the object to conduct further total internal reflection and transmit to the imaging module in which said image reflective curved surface images said light to the photosensitive unit which senses image information corresponding to the contact position; the microprocessor detects the image information output by the photosensitive unit, obtains coordinate information of the contact position, and outputs a corresponding control signal according to position information in the image information.

According to the optical touch device using imaging module of the present invention, the imaging module is joined to the guide light plate; the photosensitive unit is joined to the imaging module.

According to the optical touch device using imaging module of the present invention, the light emitted from the light source is guided into the guide light plate via at least a guide light unit.

According to the optical touch device using imaging module of the present invention, the imaging module, the light source and the guide light unit are disposed under the guide light plate.

According to the optical touch device using imaging module of the present invention, the light source is near to the imaging module.

According to the optical touch device using imaging module of the present invention, the upper and lower surface of the guide light plate has a light absorbing zone respectively corresponding to an area surrounding the operation zone; the light shooting the light absorbing zone is absorbed instead of conducting total internal reflection propagation in the guide light plate.

According to the optical touch device using imaging module of the present invention, the absorbing zone has black color coarse structure; the guide light unit is an optical prism with triangle cross section.

According to the optical touch device using imaging module of the present invention, the imaging module has a first image reflective curved surface and a second image reflective curved surface; light shooting the image module is reflected by the first and second image reflective curved surfaces sequentially and images to the photosensitive unit; the photosensitive unit is disposed outside or inside the first and second image reflective curved surfaces.

According to the optical touch device using imaging module of the present invention, the photosensitive unit is a charge coupled device (CCD) or a complementary metal-oxide semiconductor (CMOS) sensor.

According to the optical touch device using imaging module of the present invention, the guide light plate is a bendable or unbendable plate made of guide light material.

### BRIEF DESCRIPTION OF THE DRAWINGS

FIG. 1 is a schematic diagram illustrating light moving in an optical touch device using imaging module in accordance with the present invention;

FIG. 2 is a schematic diagram illustrating an optical touch device using imaging module in accordance with the present invention;

FIG. 3 is a schematic diagram illustrating image information sensed by photosensitive units corresponding to contact positions according to the present invention;

FIG. 4 is a schematic diagram illustrating an embodiment of the imaging module having a reflective image curved surface with light path according to the present invention;

FIG. 5 is a schematic diagram illustrating the first embodiment of an imaging module having the first reflective image curved surface and the second reflective image curved surface with light path according to the present invention;

FIG. 6 is a schematic diagram illustrating the second embodiment of an imaging module having the first reflective image curved surface and the second reflective image curved surface with light path according to the present invention.

### DETAILED DESCRIPTION OF THE INVENTION

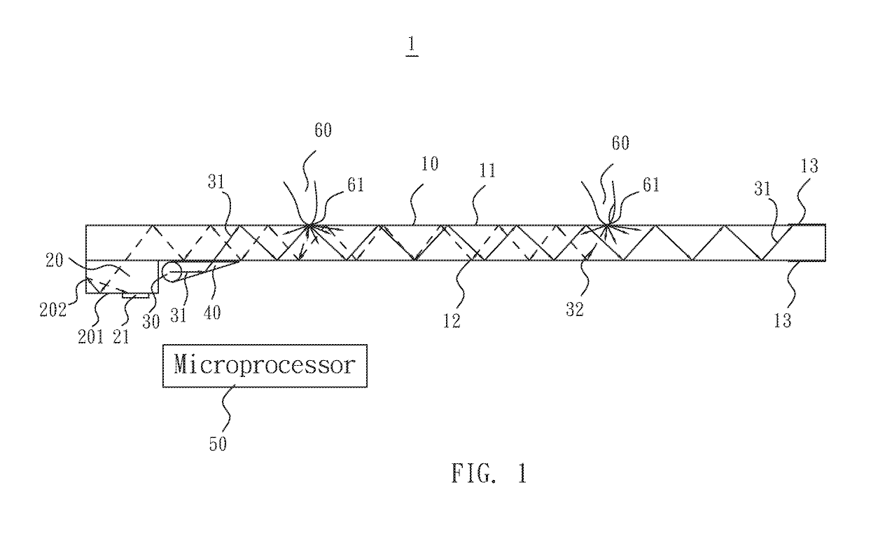

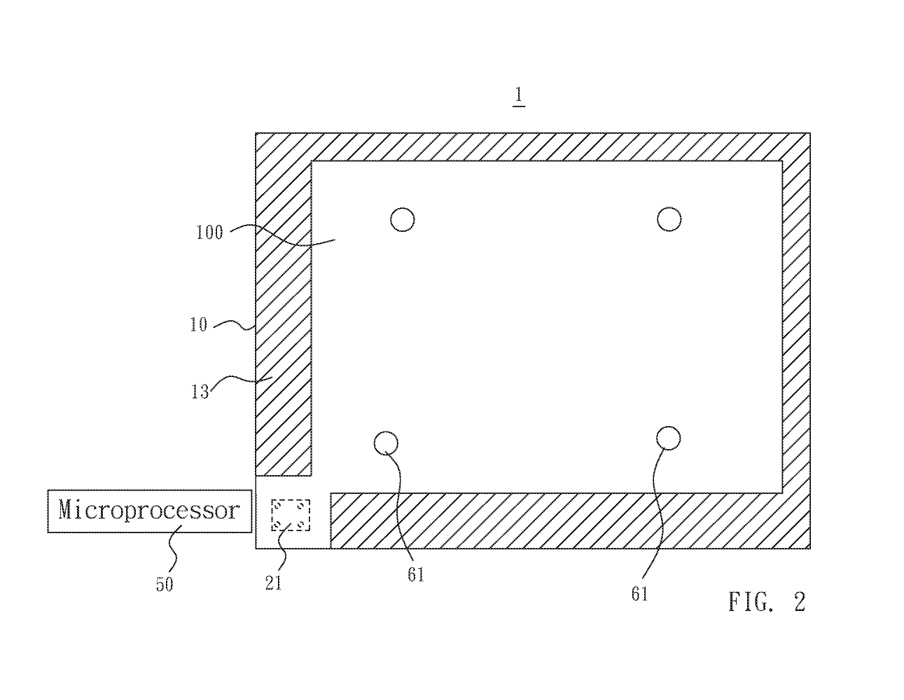

Referring to FIGS. 1 and 2, an optical touch device using imaging module 1 according to the present invention comprises a guide light plate 10, an imaging module 20, at least a light source 30, at least a guide light unit 40, at least a photosensitive unit 21 and a microprocessor 50. At least one of the photosensitive units 21 connects with the microprocessor 50 electrically.

The guide light plate 10 has an upper surface 11 and a lower surface 12 being parallel to each other. The guide light plate 10 joins the imaging module 20. The upper surface 11 of the guide light plate 10 has an operation zone 100 corresponding to the imaging module 20. The upper surface 11 and the lower surface 12 of the guide light plate 10 have a light absorbing zone 13 surrounding the operation zone 100, respectively. The light absorbing zone 13 is provided with a black color course structure to absorb the light conducting total reflection between the upper and lower surfaces 11, 12 when the light absorbing zone 13 is irradiated by the light. As a result, the total reflection propagation in the guide light plate 10 is unable to proceed.

In the present embodiment, at least a light source 30 and a guide light unit 40 are disposed under the guide light plate 10. Light 31 emitting from at least a light source 30 is guided into the guide light plate 10 via at least a guide light unit 40 to shine the entire operation zone 100 and conducts the total internal reflection propagation between areas of the upper and lower surfaces 11, 12 corresponding to the operation zone 100.

The imaging module 20, which is joined to the guide light plate 10, is disposed below the lower surface 11 outside the operation zone 100. The imaging module 20 is made of transparent material such as acrylic or glass and provided with a first image reflective curved surface 201 and a second reflective imaging curved surface 202. At least a photosensitive unit 21 is disposed at the imaging side of the imaging module 21 under the guide light plate 10. Light emitted in the area of the operation zone 100 enters the imaging module 20 and is reflected to at least a photosensitive unit 21 by the first image reflective curved surface 201 and the second image reflective curved surface 202 sequentially such that at least a photosensitive unit 21 senses image information corresponding to the operation zone 100. In the present embodiment, the imaging module 20 is close to the light source 30.

When no object contacts the operation zone 100 of the guide light plate 10, the light 31 emitting from the light source 30 is guided into the guide light plate 10, conducts the total reflection propagation between the upper and lower surfaces 11, 12, shoots the light absorbing zone 13 surrounding the operation zone 100, and is absorbed by the absorbing zone 13 instead of conducting the total reflection propagation between the upper and lower surfaces 11, 12 and shooting the imaging module 20. Under the circumstances, no image is sensed by the photosensitive unit 21 due to no light shooting the imaging module 20 and the photosensitive unit 21.

When at least an object 60 contacts the operation zone 100 of the guide light plate 10, the light 31 emitting from the light source 30 is guided into the guide light plate 10, conducts the total reflection propagation between the upper and lower surfaces 11, 12, and shoots a contact position 61 of the object 60 contacting the operation zone 100 of the guide light plate 10; due to the object 60 shot by the light 31 generating a phenomenon of frustrated total internal reflection, part of the light 32 scattered by the object 60 conducts the total reflection propagation in the guide light plate 10 forwards to shoot the imaging module 20 and is imaged to at least a photosensitive unit 21 by the first image reflective curved surface 201 and the second image reflective curved surface 202 sequentially; at least a photosensitive unit 21 senses image information corresponding to at least an object 60 contacting the operation zone 100 of the guide light plate 10; the microprocessor 50 detects the image information output by the photosensitive unit 21, obtains coordinate information of at least a contact position 61 of the object 60 touching the guide light plate 10, and outputs a corresponding control signal according to position information of at least a contact position 61 in the image information.

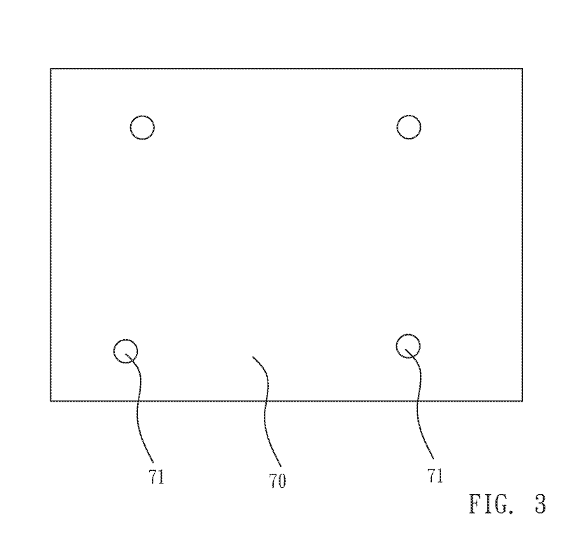

Referring to FIG. 3 and companying with FIGS. 1 and 2, the microprocessor 50 detects the image information 70 output by the photosensitive unit 21, obtains coordinate information (such as coordinates in an X-Y coordinate system) of at least a contact position 61 of at least an object 60 touching the guide light plate 10 according to position information of at least a contact image 71 in the image information 70, and outputs a corresponding control signal.

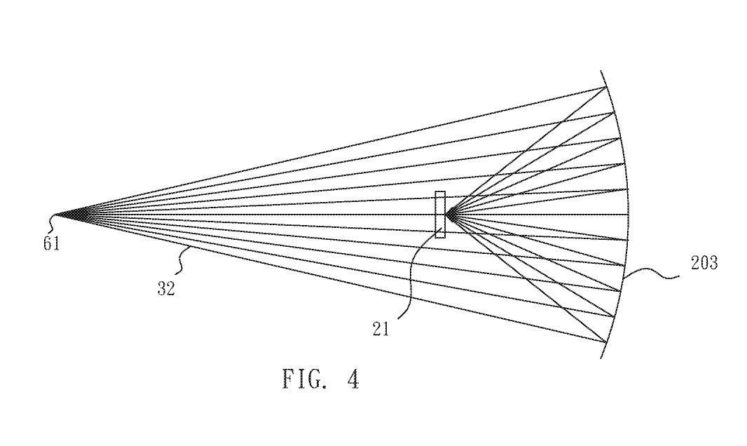

Referring to FIG. 4, an embodiment of the imaging module with an image reflective curved surface 203 is illustrated. Light 32 reflected by the contact position 61 is transmitted to the imaging module via the total internal reflection and reflected to the photosensitive unit 21 by the image reflective curved surface 203, and the photosensitive unit 21 senses image information corresponding to the contact position 61.

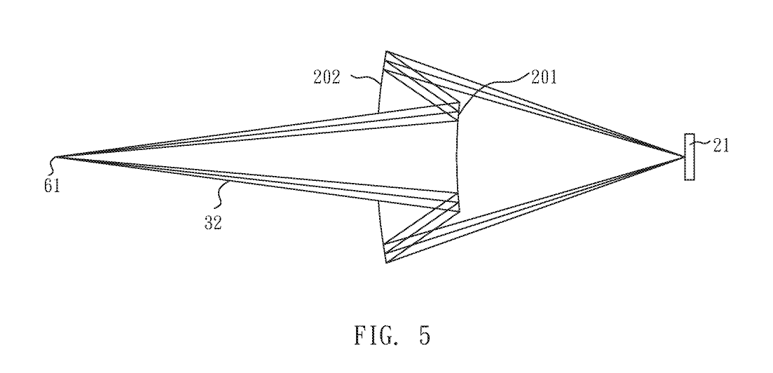

Referring to FIG. 5, the first embodiment of the imaging module with the first image reflective curved surface 201 and the second image reflective curved surface 202 is illustrated. Light 32 reflected by the contact position 61 is transmitted to the imaging module via the total internal reflection and reflected to the photosensitive unit 21 by the first image reflective curved surface 201 and the second image reflective curved surface 202 sequentially, and the photosensitive unit 21 senses image information corresponding to the contact position 61. The photosensitive unit 21 in the present embodiment is disposed outside the first image reflective curved surface 201 and the second image reflective curved surface 202.

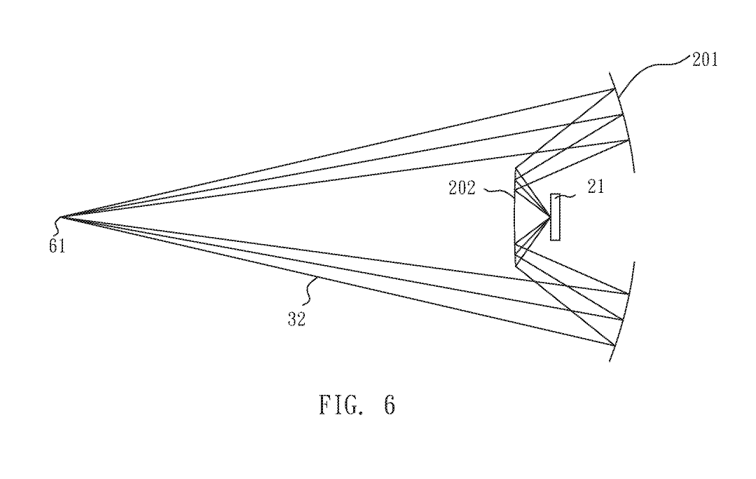

Referring to FIG. 6, the second embodiment of the imaging module with the first image reflective curved surface 201 and the second image reflective curved surface 202 is illustrated. Light 32 reflected by the contact position 61 is transmitted to the imaging module via the total internal reflection and reflected to the photosensitive unit 21 by the first image reflective curved surface 201 and the second image reflective curved surface 202 sequentially, and the photosensitive unit 21 senses image information corresponding to the contact position 61. The photosensitive unit 21 in the present embodiment is disposed between the first image reflective curved surface 201 and the second image reflective curved surface 202.

The image reflective curved surfaces disclosed in the present invention can be concave inward spherical surfaces or non-concave inward spherical surfaces. Alternatively, the outer surface of the imaging module in the present invention can be provided with at least a reflective membrane to form at least an image reflective curved surface.

lights emitted from multiple light sources can be employed in the present invention to be guided to the light guide plate simultaneously to conduct total reflection propagation respectively. Nevertheless, the microprocessor has to be capable of precluding images in the image information which are produced by the light sources or guide light units.

The guide light plate in the present invention can be provided without the light absorbing zone. Nevertheless, the microprocessor has to be capable of precluding images which are not corresponding to the contact position.

The photosensitive unit in the present invention can be a charge coupled device (CCD) or a complementary metal-oxide semiconductor (CMOS) sensor; the transparent plate can be made of transparent acrylic, resin or glass; the guide light plate can be a bendable or unbendable plate made of guide light material such as acrylic, resin or glass; the guide light unit can be an optical prism with a triangle cross section.

It is appreciated that merely a single imaging module disclosed in the present invention with a photosensitive unit is capable of imaging multiple contact positions to the photosensitive unit conveniently to form image information corresponding to the contact positions and generate corresponding touch signals. That is, the images at where an object contacts the guide light plate are utilized directly to generate the touch signals instead of detecting attenuation signal of frustrated total internal reflection resulting from the object contacting the guide light plate. It is a great breakthrough of technology related to guide light plate touch device.

Due to only an imaging module and a photosensitive unit is applied in the optical touch device with imaging module in accordance with the present invention, the light propagation in the guide light plate being employed to conduct the total internal reflection to attain touch control function can reduce components needed in the touch device and save fabrication cost largely.

Although the invention has been described in relation to its preferred embodiments, it is to be understood that many other possible modifications and variations can be made without departing from the spirit and scope of the invention as hereinafter claimed.

What is claimed is:

1. An optical touch device using imaging module, comprising:
a guide light plate having an upper surface and a lower surface being parallel to each other, and an operation zone disposed on the upper surface;
at least a light source emitting light being guided into the guide light plate and conducting total internal reflection propagation between the upper and lower surfaces;
an imaging module corresponding to said operation zone and having at least an image reflective cured surface;
at least a photosensitive unit corresponding to said imaging module;
during the emitted light within said operation zone shooting said imaging module and being imaged to said photosensitive unit by said image reflective curved surface, said photosensitive unit sensing image information corresponding to an image in said operation zone; and
a microprocessor electrically connecting said photosensitive unit;
wherein when the light emitted by said light source is guided into the guide light plate to conduct total internal reflection propagation and at least an object touches at least a contact position in said operation zone, the total internal reflection is frustrated at the time of the light irradiating said contact position and reflected by said object to conduct further total internal reflection and shoot said imaging module in which said image reflective curved surface images said light to said photosensitive unit which further senses image information corresponding to said contact position; said microprocessor detects said image information output by said photosensitive unit, obtains coordinate information of said contact position, and outputs a corresponding control signal according to position information in said image information.

2. The optical touch device using imaging module as defined in claim 1, wherein said imaging module is joined to said guide light plate; said photosensitive unit is joined to said imaging module.

3. The optical touch device using imaging module as defined in claim 2, wherein the light emitted from said light source is guided into said guide light plate via at least a guide light unit.

4. The optical touch device using imaging module as defined in claim 3, wherein said imaging module, said light source and said guide light unit are disposed under said guide light plate.

5. The optical touch device using imaging module as defined in claim 4, wherein said light source is near to said imaging module.

6. The optical touch device using imaging module as defined in claim 5, wherein the upper and lower surface has a light absorbing zone respectively corresponding to an area surrounding said operation zone; the light shooting the light absorbing zone is absorbed instead of conducting total internal reflection propagation in said guide light plate.

7. The optical touch device using imaging module as defined in claim 6, wherein said absorbing zone has black color coarse structure; said guide light unit is an optical prism with triangle cross section.

8. The optical touch device using imaging module as defined in claim 7, wherein said imaging module has a first image reflective curved surface and a second image reflective curved surface; light shooting said image module is reflected by said first and second image reflective curved surfaces sequentially to image to said photosensitive unit; said photosensitive unit is disposed outside or between the first and second image reflective curved surfaces.

9. The optical touch device using imaging module as defined in claim 8, wherein said photosensitive unit is a charge coupled device (CCD) or a complementary metal-oxide semiconductor (CMOS) sensor.

10. The optical touch device using imaging module as defined in claim 9, wherein said guide light plate is a bendable or unbendable plate made of guide light material.
